(19) United States
(12) Patent Application Publication
(10) Pub. No.: US 2022/0262371 A1
(43) Pub. Date: Aug. 18, 2022

(54) VOICE REQUEST SEQUENCING

(71) Applicant: Cerence Operating Company, Burlington, MA (US)

(72) Inventors: Prateek Kathpal, San Mateo, CA (US); Nils Lenke, Aachen (DE)

(21) Appl. No.: 17/174,715

(22) Filed: Feb. 12, 2021

(51) Int. Cl. G10L 17/22; G10L 17/06; G10L 21/0272

(52) U.S. Cl. CPC G10L 17/22; G10L 21/0272; G10L 17/06

(57) ABSTRACT

A method includes receiving, at a voice assistant, data representing a number of requests spoken by a number of speakers, processing the data representing the number of requests to identify a number of commands associated with the number of requests, processing the number of commands to determine a number of responses corresponding to the number of requests, ordering the number of responses according to a sequencing objective, and providing the ordered number of responses for presentation to the number of speakers.

### BACKGROUND OF THE INVENTION

This invention relates to sequencing the servicing of multiple voice requests received at a voice assistant.

Voice assistants have become increasingly prevalent in people's homes, vehicles, and in certain public spaces. A typical voice assistant monitors its environment to identify requests spoken by individuals in the environment. Identified requests are processed by the voice assistant to generate spoken response (e.g., answers to questions) or to cause actions to occur (e.g., turning on the lights).

The prototypical use case for a voice assistant includes an individual in the same environment as a voice assistant speaking a request to the voice assistant. The voice assistant receives and processes the request to formulate a response, which it presents to the individual. For example, an individual in a vehicle might say “Hey Assistant, how long until we are home?” The voice assistant would process the request and then respond to the individual with “We will be home in about 25 minutes.”

If multiple individuals speak requests to a voice assistant at the same time (i.e., the requests at least partially overlap in time), the voice assistant may, for example, either issue an error message or chooses one speaker's request as the winning request for servicing and ignores the requests from other speakers.

### SUMMARY OF THE INVENTION

Voice assistants are generally deployed to serve a single location and to service voice requests one at a time. If multiple people are present, they are seen as potential sources of interference and their speech may be eliminated using, for example, acoustic beamforming, speaker separation, and noise cancellation techniques.

However, it is becoming increasingly common for multiple individuals in the same environment to vie for access to a voice assistant in the environment. For example, certain vehicles such as cars and buses may include multiple microphones distributed throughout the vehicle that allow passengers and drivers to speak requests. Similarly, in the home, family members and guests frequently interact with smart speakers. In any of these scenarios, the individuals' spoken requests may at least partially overlap in time, causing errors or missed requests.

Aspects described herein address the problem of errors and missed requests due to overlapping messages (e.g., overlapping utterances or multi-turn dialogs) by separating spoken requests using, for example, acoustic beamforming and/or voice biometrics and speech diarization techniques. The requests are then answered in a sequential way (e.g., in a first-in-first-out order, last-in-first-out order, or in an order of urgency).

In a general aspect, a method includes receiving, at a voice assistant, data representing a number of requests spoken by a number of speakers, processing the data representing the number of requests to identify a number of commands associated with the number of requests, processing the number of commands to determine a number of responses corresponding to the number of requests, ordering the number of responses according to a sequencing objective, and providing the ordered number of responses for presentation to the number of speakers.

Aspects may include one or more of the following features.

At least some requests of the number of requests may be temporally overlapping. At least some of the requests may be part of one or more dialogues between a corresponding one or more speakers of the number of speakers and the voice assistant. Each dialogue of the one or more dialogues may include one or more requests and one or more responses, and the requests and responses of the one or more dialogues are interleaved.

Processing the data representing the number of requests to identify a number of commands may include performing a speaker diarization operation on the data representing the number of requests. The speaker diarization operation may include performing a speaker separation operation on the data representing the number of requests to generate speaker specific audio data for each speaker of the number of speakers. The speaker separation operation may include an acoustic beamforming operation. The speaker separation operation may be based on voice biometrics. The speaker separation operation may be further based on an acoustic beamforming operation.

The speaker diarization operation may further include performing an automatic speech recognition operation on the speaker specific audio data for each speaker of the number of speakers to generate textual data associated with each speaker of the number of speakers. The method may include processing the textual data associated with each speaker of the number of speakers to identify the number of commands.

The sequencing objective may specify that the responses be ordered by relative urgency of their associated requests. The sequencing objective may specify that the responses be ordered in a first-in-first-out order. The sequencing objective may specify that the responses be ordered in a last-in-first-out order.

In another general aspect, a method includes receiving, at a voice assistant, a first request from a first speaker and a second request from a second speaker, processing, using the voice assistant, the first request and the second request to determine a corresponding first answer and second answer, determining an order of presentation of the first answer and the second answer based at least in part on a sequencing objective, and presenting the first answer and the second answer according to the determined order of presentation.

Aspects may include one or more of the following features.

The order of presentation may be determined according to an importance associated with the first and second requests. The order of presentation may be determined according to a timeline associated with the first and second requests. The first answer and the second answer may be presented with corresponding request identifiers. The first answer and the second answer may be presented with corresponding speaker identifiers. The determined order of presentation may be different from the order in which the first request and the second request were received.

Presenting the first answer and the second answer may include forming a combined answer by combining the first answer and the second answer and presenting the combined answer. Forming the combined answer may include modifying one or more of the first answer and the second answer based on n relationship between the first answer and the second answer.

Other features and advantages of the invention are apparent from the following description, and from the claims.

### BRIEF DESCRIPTION OF THE DRAWINGS

FIG. 1 is a vehicle carrying passengers who are speaking requests to an in-vehicle voice assistant.

FIG. 2 shows the in-vehicle voice assistant of the vehicle of FIG. 1 responding the requests from the passengers.

FIG. 3 is a voice assistant.

FIG. 4 shows a second embodiment of the in-vehicle voice assistant of the vehicle of FIG. 1 responding the requests from the passengers.

FIG. 5 shows a third embodiment of the in-vehicle voice assistant of the vehicle of FIG. 1 responding the requests from the passengers.

FIG. 6 shows a fourth embodiment of the in-vehicle voice assistant of the vehicle of FIG. 1 responding the requests from the passengers.

FIG. 7 shows a fifth embodiment of the in-vehicle voice assistant of the vehicle of FIG. 1 responding the requests from the passengers.

### DETAILED DESCRIPTION

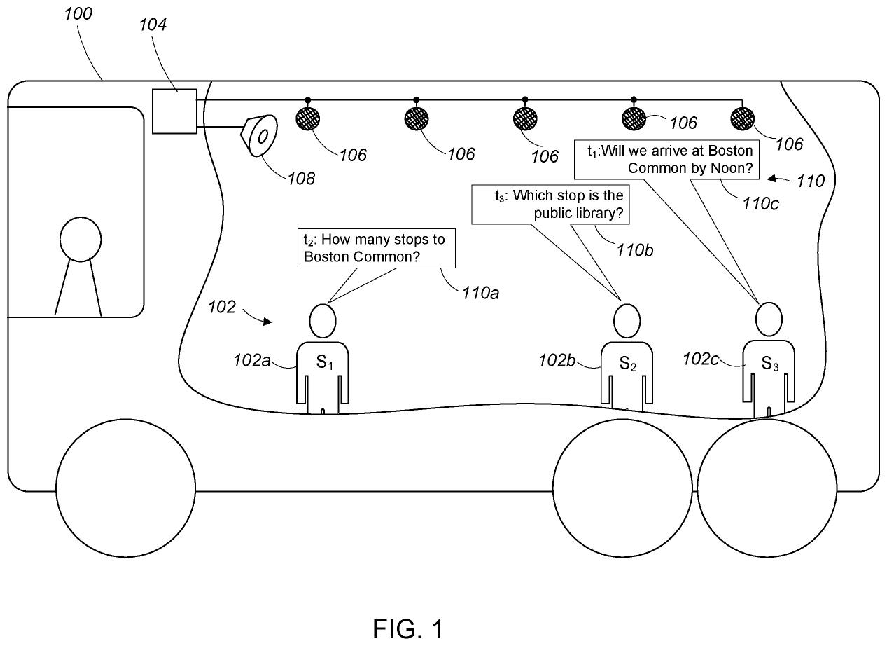

Referring to FIG. 1, a vehicle (e.g., a bus) 100 for transporting passengers 102 includes a voice assistant 104. Very generally, the voice assistant 104 is configured to service multiple, potentially temporally overlapping requests 110 (e.g., utterances or multi-turn dialogs) from the passengers 102 of the vehicle and to provide responses to the requests in an order determined according to a sequencing objective.

The voice assistant 104 receives audio input from several microphones 106 distributed throughout the cabin of the vehicle 100 and provides audio output to the passengers 102 using one or more loudspeakers 108. The passengers 102 interact with the voice assistant 104 by speaking requests 110, which are captured by the microphones 106 and transmitted to the voice assistant 104. The voice assistant 104 processes the requests 110 to formulate responses, which are broadcast throughout the cabin of the vehicle 100 using the loudspeaker 108.

In some examples, the requests 110 spoken by the passengers 102 at least partially overlap in time (i.e., two or more of the passengers are speaking requests at the same time). For example, at time t₁, passenger S₃ 102c speaks a first request 110c, “Will we arrive at Boston Common by Noon?”. At time t₂, passenger S₁ 102a speaks a second request 110a, “How many stops to Boston Common?”. At time t₃, passenger S₂ 102b speaks a third request 110b, “Which stop is the public library?”.

In this example, the first request 110c, the second request 110a, and the third request 110b are temporally overlapping. The spoken requests 110 are received at the microphones 106, each of which generates an audio signal representing a combination of the spoken requests 110 at the microphone.

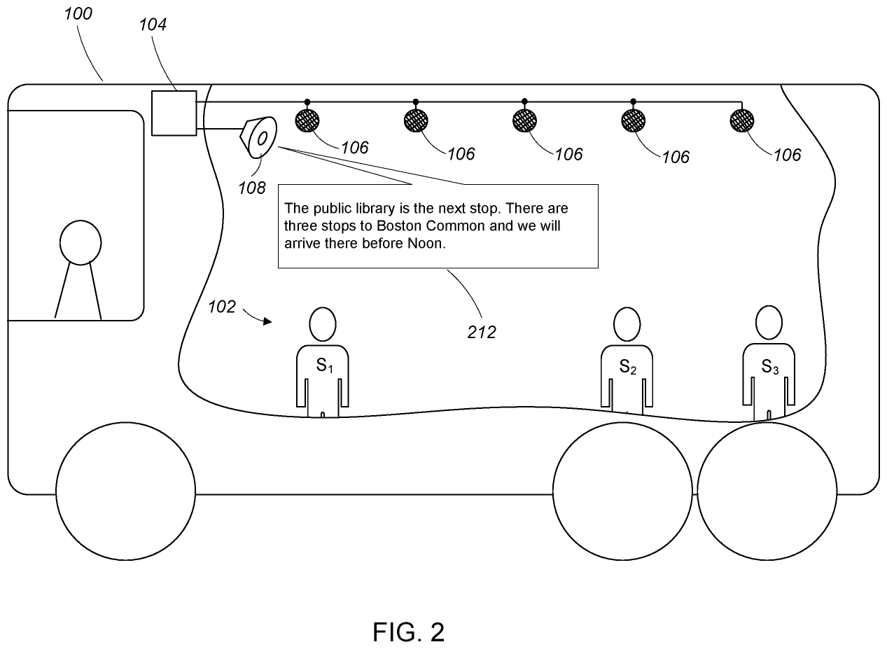

Referring to FIG. 2, the audio signals from the microphones 106 are provided to the voice assistant 104, which processes the audio signals to generate a response 212 to the requests. In this example, the response is ordered according to a sequencing objective specifying that (1) responses to urgent requests are provided before non-urgent requests and (2) responses to related requests are combined where possible.

In the example, the public library is the next stop for the vehicle 100, so the response to the third request 110b made at time t₃ is the most urgent because passenger S₂ 102b needs to be quickly informed that their stop is next. The response to the third request 110b is therefore ordered first in the response 212 and states “The public library is the next stop.” The responses to the first request 110c made at time t₁ and the second request 110a made at time t₂ are less urgent but are related and can therefore be combined as “There are three stops to Boston Common and we will arrive there before Noon” in the response 212. The response 212 that is broadcast to the passengers 102 is therefore “The public library is the next stop. There are three stops to Boston Common and we will arrive there before Noon.”

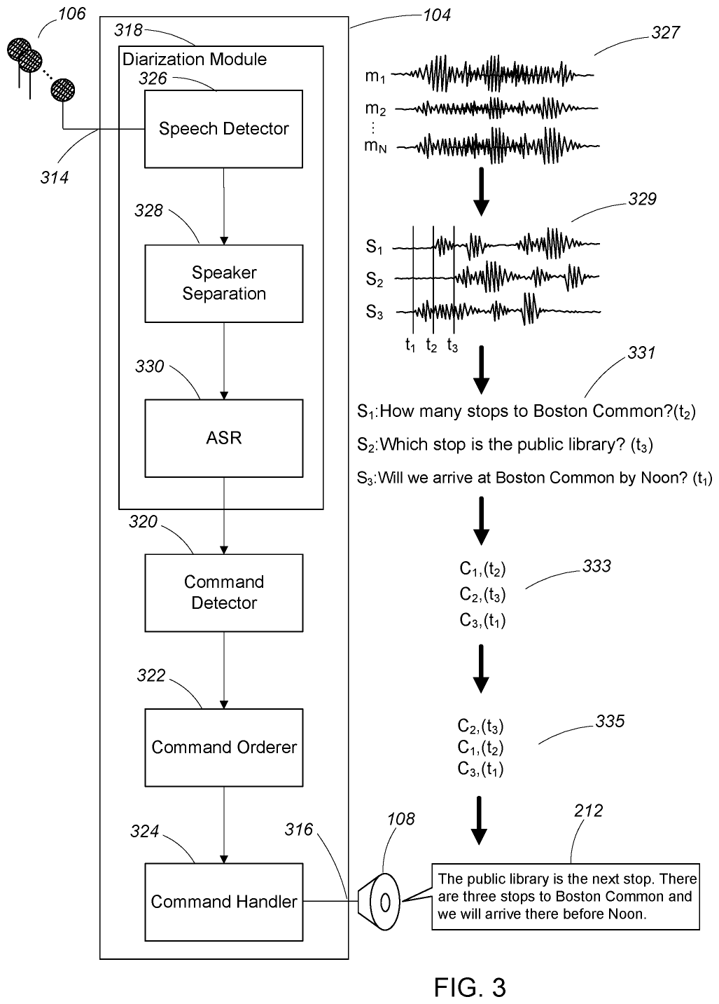

Referring to FIG. 3, the voice assistant 104 includes an input 314 for receiving input signals from the microphones 106 and an output 316 for providing response output to the loudspeaker 108. The input signals are processed in a diarization module 318, a command detector 320, a command orderer 322, and a command handler 324 to generate the response output 212.

The diarization module 318 includes a speech detector 326, a speaker separation module 328, and an automatic speech recognition module 330. The input signals from the microphones 106 are provided to the speech detector 326, which monitors the signals to detect when speech is present in the signals (as opposed to, for example, road noise or music playing). When the speech detector 326 detects one or more microphone signals including speech 327, the detected microphone signals 327 are provided to the speaker separation module 328. In the example of FIG. 1, three passengers 102 speak temporally overlapping requests, which are detected by the speech detector 326, resulting in the microphone signals including speech 327.

At least some of the microphone signals including speech 327 may include the speech of multiple speakers (multiple passengers 102 in this case). The speaker separation module 328 processes the microphone signals including speech 327 to separate the speech signals 329 corresponding to each of the multiple speakers. The speech signals 329 are stored in association with a speaker identifier (e.g., S₁, S₂, S₃). In some examples, the speech signals 329 are separated using one or more of acoustic beamforming and voice biometrics (e.g., based on an average or variability of spectral characteristics, pitch, etc.). In the example of FIG. 1, there are three speakers (i.e., S₁, S₂, S₃), resulting in three speech signals 329.

The speech signals 329 are provided to the automatic speech recognition module 330, which generates a transcript 331 for each of the speech signals 329. Each transcript 331 is stored in association with its respective speaker identifier (e.g., S₁, S₂, S₃) and a timestamp (e.g., t₁, t₂, t₃) indicating when the speech began or another attribute that can be used to determine an order of receipt of the different speakers' speech at the voice assistant 104. In the example of FIG. 1, the transcripts 331 include a transcript for each of the three requests 110 spoken by the passengers 102.

The transcripts 331 are provided to the command detector 320, which parses the transcripts 331 to determine if the transcripts 331 include commands that are serviceable by the command handler 324. For example, a transcript including the phrase “Which stop is the public library” represents a command that is serviceable by the command handler 324 whereas a transcript including the phrase “Did you remember to call your mother back?” does not represent a command that is serviceable by the command handler 324. Corresponding commands 333 are created for any transcripts that include phrases representing commands that are serviceable by the command handler 324, with each command being associated with a timestamp (e.g., t₁, t₂, t₃) indicating when the speech began or another attribute that can be used to determine an order of receipt of the different speakers' speech at the voice assistant 104. In the example of FIG. 1, the commands include a command for each of the three requests 110 spoken by the passengers 102: C₁, (t₂), C₂, (t₃), C₃, (t₁). In some examples, the command detector 320 uses natural language understanding techniques to determine attributes such as a relative urgency of the commands, relationships between the commands. In other examples, the relative urgency of the commands can be determined from one or more of voice biometrics, facial recognition, and location information (e.g., using model-based classification or scoring). The commands 333 are associated with those attributes for use by the command orderer 322.

The commands 333 are provided to the command orderer 322, which processes the commands to reorder them according to a sequencing objective. As is mentioned above, in the example of FIG. 1, the sequencing objective specifies that (1) responses to urgent requests are provided before non-urgent requests and (2) responses to related requests are combined where possible. Other sequencing objectives are possible. For example, the commands may be ordered according to a first-in-first-out or a last-in-first-out sequencing objective. Commands may be sequenced according to a location of the speakers (e.g., respond to the driver of a car first). Commands may be sequenced according to a determined identity of the speakers (e.g., respond to Mom first).

In the example of FIG. 1, the command associated with the third request 110b made at time t3 is the most urgent because passenger S2 102b needs to be quickly informed that their stop is next. The command orderer 322 therefore moves the command, C2 associated with the third request 110b to be first in an ordered list of commands 335. The commands, C1 and C3, associated with the first request 110c and the second request 110a are less urgent but are related and are therefore ordered after C2 and adjacent to each other in the list of commands 335. In some examples the list of commands 335 includes metadata characterizing the commands such as command ordering information, urgency information or relationship information indicating relationships that exist between two or more of the commands.

The ordered list of commands 335 is provided to the command handler 324, which processes the commands in the list to generate the response 212. In general, the command handler 324 includes a software agent configured to perform tasks or services based on the commands that it receives. One example of a command handler 324 is described in relation to the language processor described in U.S. patent application Ser. No. 17/082,632 (PCT/US20/57662), the entire contents of which are incorporated by reference herein.

In the example of FIG. 1, the command handler 324 processes command, C2 associated with the third request 110b first to generate a first partial response “The public library is the next stop.” The command handler 324 then processes command C₁ associated with the second request 110a to generate a second partial response “There are three stops to Boston Common.” The command handler then processes command C₃ associated with the first request 110c to generate a third partial response “We will arrive at Boston Common before Noon.”

The command handler 324 then processes the partial responses according to the order of the commands in the list of commands 335 or metadata associated with the ordered list of commands 335 (or both) to generate the response 212. For example, the command handler 324 ensures that the first partial response “The public library is the next stop” comes first in the response 212 because the metadata indicates that it is the most urgent of the partial responses. The command handler then combines the second and third partial responses into a combined partial response “The are three stops to Boston Common and we will arrive there before Noon” because the metadata indicates that those two partial responses are related to each other. The first partial response and the combined partial response are combined to form the response 212 “The public library is the next stop. There are three stops to Boston Common and we will arrive there by Noon.” The response 212 is output from the voice assistant 104 to the loudspeaker 108, which plays the response 212 to the passengers 102 in the bus.

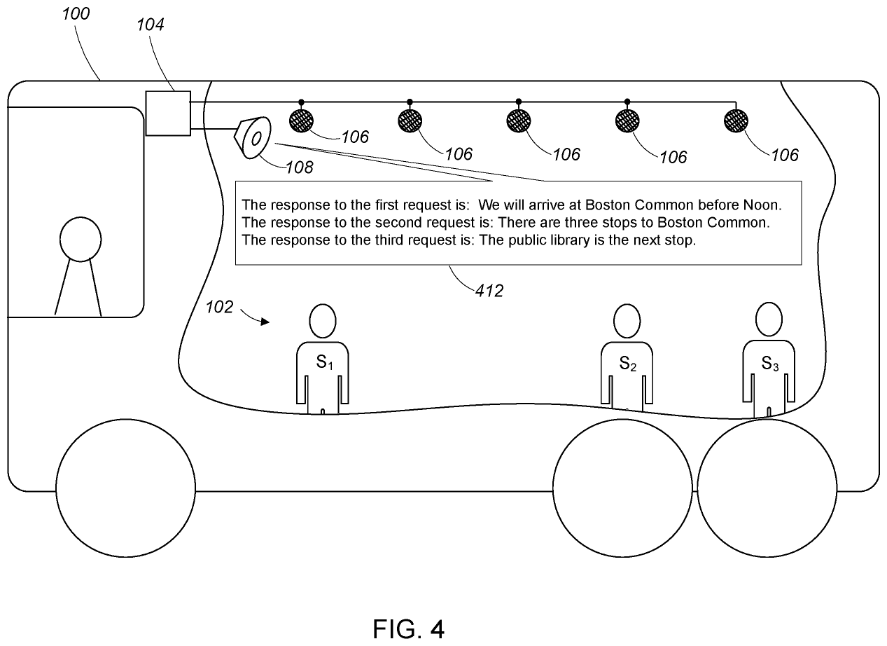

Referring to FIG. 4, in another example, the voice assistant 104 is configured to respond to requests in a first-in-first-out order and to prefix each response with a request identifier. For example, the response to the first request 110c is prefixed with “The response to the first request is:,” the response to the second request 110a is prefixed with “The response to the second request is:,” and the response to the third request 110 is prefixed with “The response to the third request is:.” The response 412 broadcast to the passengers is therefore: “The response to the first request is: We will arrive at Boston Common before Noon. The response to the second request is: There are three stops to Boston Common. The response to the third request is: The public library is the next stop.”

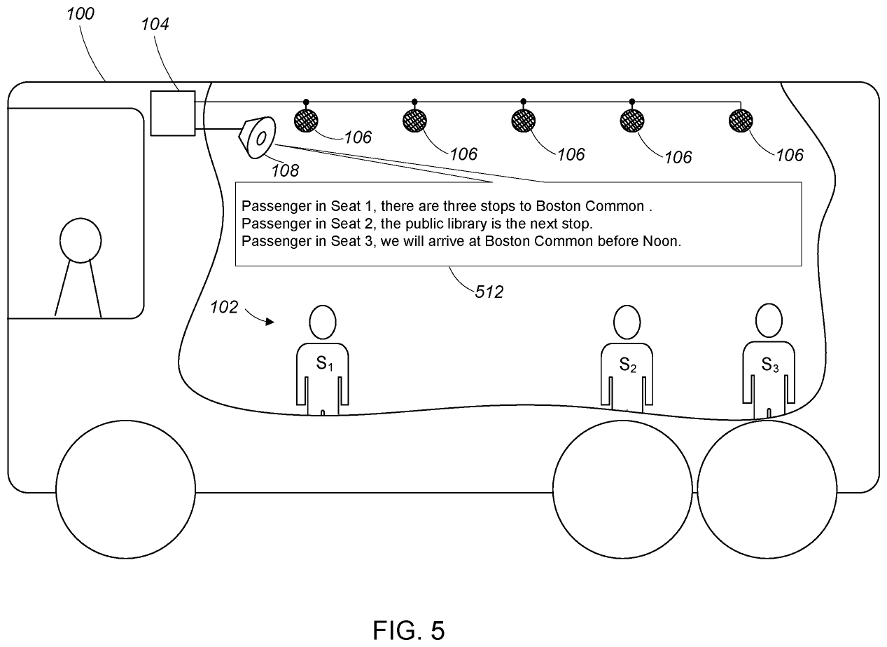

Referring to FIG. 5, in some examples, the voice assistant 104 has access to location information of each of the passengers 102 that has spoken a request (e.g., by way of acoustic beamforming). For example, the voice assistant 104 may know the seat number of each of the passengers 102 that has spoken a request. In such an example, the voice assistant 104 responds to requests by prefixing each response with an indication of the location of the passenger that spoke the request. For example, the response to the second request 110a is prefixed with “Passenger in Seat 1,” the response to the third request 110b is prefixed with “Passenger in Seat 2,” and the response to the first request 110c is prefixed with “Passenger in Seat 3.” The response 512 broadcast to the passengers is therefore: “Passenger in seat 1: There are three stops to Boston Common. Passenger in Seat 2, the public library is the next stop. Passenger in Seat 3, we will arrive at Boston Common before Noon.”

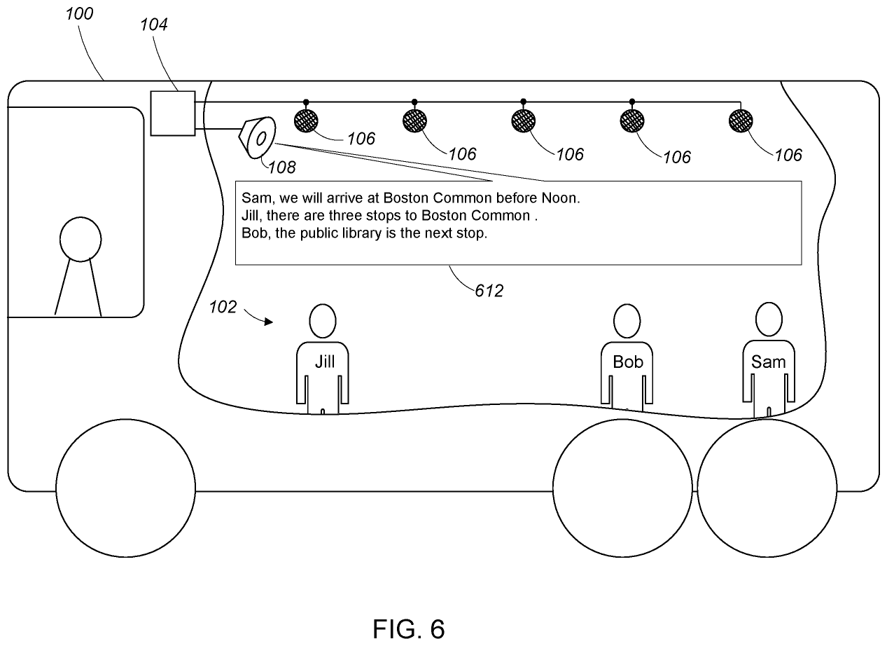

Referring to FIG. 6, in some examples, the voice assistant 104 uses voice biometrics to personally identify the passengers 102 that speak requests. For example, the voice assistant 104 may have a stored voice profile for the passengers. In such an example, the voice assistant 104 responds to requests by prefixing reach response with a personal identifier for the passenger that spoke the request. For example, the response to the first request 110c is prefixed with “Sam,” the response to the second request 110a is prefixed with “Jill,” and the response to the third request 110b is prefixed with “Bob.” The response 612 broadcast to the passengers is therefore: “Sam, we will arrive at Boston Common before Noon. Jill, there are three stops to Boston Common. Bob, the public library is the next stop.”

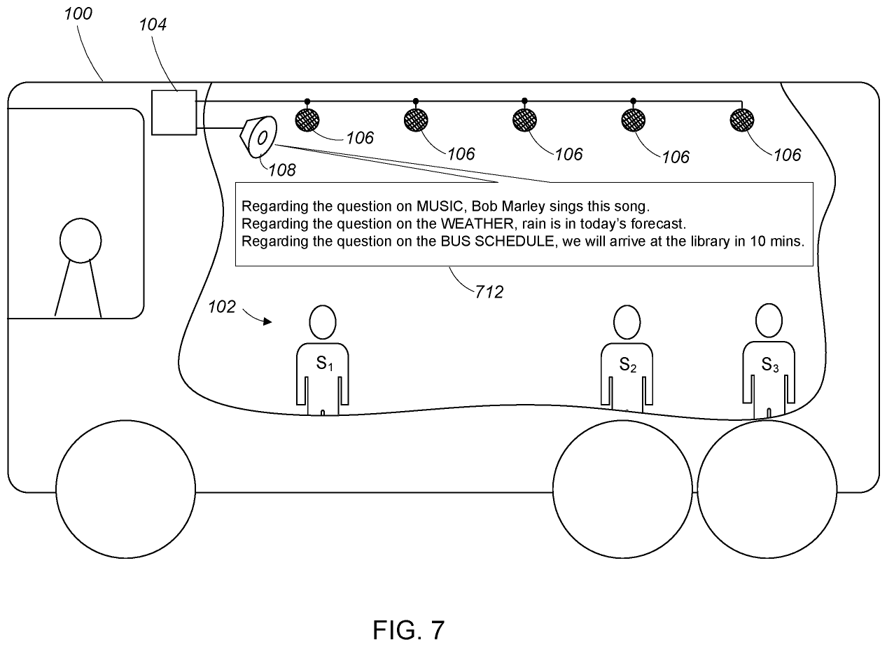

Referring to FIG. 7, in some examples, the voice assistant 104 categorizes the requests according to topic and then prefixes its responses to the requests with their associated topic. For example, the voice assistant may receive three requests: one related to music, one related to the weather, and another related to the bus schedule. The voice assistant 104 categorizes the requests according to topic and prefixes its responses to the requests with the topic. One example of such a response is “Regarding the question on MUSIC, Bob Marley sings this song. Regarding the question on the WEATHER, rain is in today's forecast. Regarding the question on the BUS SCHEDULE, we will arrive at the library in 10 mins.”

### 1 Alternatives

In some examples, the command handler described above processes commands sequentially in the order that they are received. In other examples, the command handler processes the commands in parallel and orders the responses. In other examples, the command handler is free to make changes to the order of processing and the ordering of the responses.

While the examples described above are described in the context of a bus, it is noted that the same techniques and ideas can be applied in other vehicles such as personal passenger vehicles, airplanes, etc. Furthermore, the techniques and ideas can be applied in a home setting (e.g., in a living room or kitchen) or in a public space.

In some examples, the interactions between speakers and the voice assistant are referred to as “dialogues,” where a dialogue includes at least one request from a speaker and at least one response to that request. Dialogues can also include multi-turn interactions between a speaker and the voice assistant. For example, the voice assistant may respond to a speaker's request with a question that the user response to. Such dialogues may be temporally interleaved. For example, one speaker's request and another speaker's request may be received at the voice assistant before the voice assistant has an opportunity to respond to either request. In such examples, the voice assistant orders its responses according to an ordering objective (e.g., an order of receipt, and importance of a speaker, a priority of a request, etc.).

In some examples, multiple responses are combined using a simple “and” between the responses. However, in other examples, multiple responses are combined intelligently (e.g., based on a relationship between the responses). For example, if one person makes a request such as “when will we arrive at Boston common?” and another person makes a request such as “do I need to wear a mask on Boston Common”, the system could provide a combined response such as “We will arrive at Boston common at noon and you need to wear a mask there.”

### 2 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method comprising:
receiving, at a voice assistant, data representing a plurality of requests spoken by a plurality of speakers;
processing the data representing the plurality of requests to identify a plurality of commands associated with the plurality of requests;
processing the plurality of commands to determine a plurality of responses corresponding to the plurality of requests;
ordering the plurality of responses according to a sequencing objective; and
providing the ordered plurality of responses for presentation to the plurality of speakers.

2. The method of claim 1 wherein at least some requests of the plurality of requests are temporally overlapping.

3. The method of claim 1 wherein at least some of the requests are part of one or more dialogues between a corresponding one or more speakers of the plurality of speakers and the voice assistant.

4. The method of claim 3 wherein each dialogue of the one or more dialogues includes one or more requests and one or more responses, and the requests and responses of the one or more dialogues are interleaved.

5. The method of claim 1 wherein processing the data representing the plurality of requests to identify a plurality of commands includes performing a speaker diarization operation on the data representing the plurality of requests.

6. The method of claim 5 wherein the speaker diarization operation includes performing a speaker separation operation on the data representing the plurality of requests to generate speaker specific audio data for each speaker of the plurality of speakers.

7. The method of claim 6 wherein the speaker separation operation includes an acoustic beamforming operation.

8. The method of claim 6 wherein the speaker separation operation is based on voice biometrics.

9. The method of claim 8 wherein the speaker separation operation is further based on an acoustic beamforming operation.

10. The method of claim 6 wherein the speaker diarization operation further includes performing an automatic speech recognition operation on the speaker specific audio data for each speaker of the plurality of speakers to generate textual data associated with each speaker of the plurality of speakers.

11. The method of claim 10 further comprising processing the textual data associated with each speaker of the plurality of speakers to identify the plurality of commands.

12. The method of claim 1 wherein the sequencing objective specifies that the responses be ordered by relative urgency of their associated requests.

13. The method of claim 1 wherein the sequencing objective specifies that the responses be ordered in a first-in-first-out order.

14. The method of claim 1 wherein the sequencing objective specifies that the responses be ordered in a last-in-first-out order.

15. A method comprising:
receiving, at a voice assistant, a first request from a first speaker and a second request from a second speaker;
processing, using the voice assistant, the first request and the second request to determine a corresponding first answer and second answer;
determining an order of presentation of the first answer and the second answer based at least in part on a sequencing objective; and
presenting the first answer and the second answer according to the determined order of presentation.

16. The method of claim 15 wherein the order of presentation is determined according to an importance associated with the first and second requests.

17. The method of claim 15 wherein the order of presentation is determined according to a timeline associated with the first and second requests.

18. The method of claim 15 wherein the first answer and the second answer are presented with corresponding request identifiers.

19. The method of claim 15 wherein the first answer and the second answer are presented with corresponding speaker identifiers.

20. The method of claim 15 wherein the determined order of presentation is different from the order in which the first request and the second request were received.

21. The method of claim 15 wherein presenting the first answer and the second answer includes forming a combined answer by combining the first answer and the second answer and presenting the combined answer.

22. The method of claim 21 wherein forming the combined answer includes modifying one or more of the first answer and the second answer based on n relationship between the first answer and the second answer.
